(19) United States
(12) Patent Application Publication
(10) Pub. No.: US 2026/0080542 A1
(43) Pub. Date: Mar. 19, 2026

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: YASUHIRO OKUNO, Tokyo (JP)

(21) Appl. No.: 19/324,961

(22) Filed: Sep. 10, 2025

(30) Foreign Application Priority Data
Sep. 18, 2024 (JP) 2024-160703

(51) Int. Cl. G06T 7/11; G06T 3/40; G06V 10/20; G06V 10/25

(52) U.S. Cl. CPC G06T 7/11; G06T 3/40; G06V 10/25; G06V 10/255; G06V 2201/07

(57) ABSTRACT

Feature(s) improve detection accuracy in object detection that detects a subject set as a detection target from an image. An information processing apparatus may estimate a detection region and a detection score regarding a subject set as a detection target with respect to an input image, generate a first detection candidate regarding detection of the subject set as the detection target with respect to a first image, calculate a region to be clipped based on the first detection candidate in a case where the first detection candidate does not include a detection candidate for which the detection score is equal to or higher than a first threshold value, generate a second image by clipping from the first image based on the region to be clipped, and generate a second detection candidate regarding the detection of the subject set as the detection target with respect to the second image.

### BACKGROUND

### Field of the Technology

The present disclosure relates to one or more embodiments of an information processing apparatus, an information processing method, and a storage medium.

### Description of the Related Art

Object detection, i.e., detection of a region of a specific object from an image has been practiced. For example, face detection, i.e., detection of a region of a human face from an image displaying a human figure as a subject has been practiced. As techniques for the object detection, learning techniques using a neural network have been developed in recent years. “CenterNet: Keypoint Triplets for Object Detection” by Kaiwen Duan, Song Bai, Lingxi Xie, Honggang Qi, Qingming Huang, and Qi Tian in ICCV 2019, pages 6569 to 6578” describes a method for detecting an object by training a neural network so as to output keypoints indicating a position of an object set as a detection target in the form of heatmaps.

### SUMMARY

One or more embodiments of the present disclosure have been made in consideration of the above-described circumstances, and are directed to improving detection accuracy in object detection that detects a subject set as a detection target from an image. In a case where the object detection is carried out, it is common to output the position and the size of a region in which a subject set as a detection target is present in an input image, and a detection score. The detection score refers to a numerical value indicating the reliability of the detection. A neural network trained to detect a specific detection target from an image outputs a high value for an image feature looking like the detection target and a low value for an image feature not looking like the detection target. The detection score is calculated based on, for example, a value of a heatmap output from the neural network. In the case of a low detection score, the detection is less reliable, i.e., is likely to be a false detection. Therefore, in a case where the detection score is lower than a predetermined threshold value, the result is treated as the detection target being not detected (as a non-detection).

The inventors of the present disclosure have observed that, in an image captured in such a manner that the size of the region of the detection target in the image, i.e., the image size of the subject, is small, the image feature looking like the detection target may be unclear and therefore may tend to be assigned with a low detection score. Therefore, in a case where the image size of the subject set as the detection target is small in the image, this often results in a detection score lower than the predetermined threshold value, ending up in a non-detection. Further, because the calculation amount in the object detection processing increases as the size of the input image increases, one may perform the object detection processing after reducing the input image size with the aim of reducing the calculation amount. This may lead to a further reduction in the image size of the subject set as the detection target, making it further likely to yield a non-detection.

At least one embodiment of an information processing apparatus according to the present disclosure may include a first detection unit that operates to estimate a detection region and a detection score regarding a subject set as a detection target with respect to an input image, a first candidate generation unit that operates to generate a first detection candidate regarding detection of the subject set as the detection target using the first detection unit with respect to a first image, a region calculation unit that operates to calculate a region to be clipped based on the first detection candidate in a case where the first detection candidate does not include a detection candidate in or for which the detection score is equal to or higher than a first threshold value, an image generation unit that operates to generate a second image by clipping from the first image based on the region to be clipped, and a second candidate generation unit that operates to generate a second detection candidate regarding the detection of the subject set as the detection target using the first detection unit with respect to the second image.

According to other aspects of the present disclosure, one or more additional information processing apparatuses, one or more methods, and one or more storage mediums are discussed herein. Features of the present disclosure will become apparent from the following description of embodiments with reference to the attached drawings. The following description of embodiments is described by way of example.

### BRIEF DESCRIPTION OF THE DRAWINGS

FIG. 1 illustrates an example of a configuration of at least one embodiment of an information processing apparatus according to one or more aspects of the present disclosure.

FIG. 2 illustrates at least one embodiment of a neural network that may be used according to one or more aspects of the present disclosure.

FIG. 3 is a flowchart illustrating at least one embodiment example of processing by at least one information processing apparatus according to one or more aspects of the present disclosure.

FIG. 4 is a flowchart illustrating at least one embodiment example of processing for calculating a region to be clipped according to one or more aspects of the present disclosure.

FIG. 5 is a flowchart illustrating at least one embodiment example of processing for calculating a region to be clipped according to one or more aspects of the present disclosure.

FIG. 6 is a flowchart illustrating at least one embodiment example of processing for calculating a region to be clipped according to one or more aspects of the present disclosure.

FIG. 7 illustrates an example of a configuration of at least one embodiment of an information processing apparatus according to one or more aspects of the present disclosure.

FIG. 8 illustrates at least one embodiment of a neural network that may be used according to one or more aspects of the present disclosure.

FIG. 9 is a flowchart illustrating at least one embodiment example of processing for calculating a region to be clipped according to one or more aspects of the present disclosure.

### DESCRIPTION OF THE EMBODIMENTS

In the following description, embodiments of the present disclosure will be described with reference to the drawings. Configurations indicated in the following embodiments are merely examples, and the present disclosure shall not be limited to the illustrated configurations. Further, the same or similar components will be identified by the same reference numerals in the drawings, and overlapping descriptions will be omitted.

An information processing apparatus according to one or more embodiments that will be described below carries out object detection of detecting a subject set as a detection target from an input image. The information processing apparatus will be described below citing an example in which the subject set as the detection target is a human face as one example, but is not limited thereto and the subject set as the detection target may be any object.

### Configuration(s) for One or More Embodiments

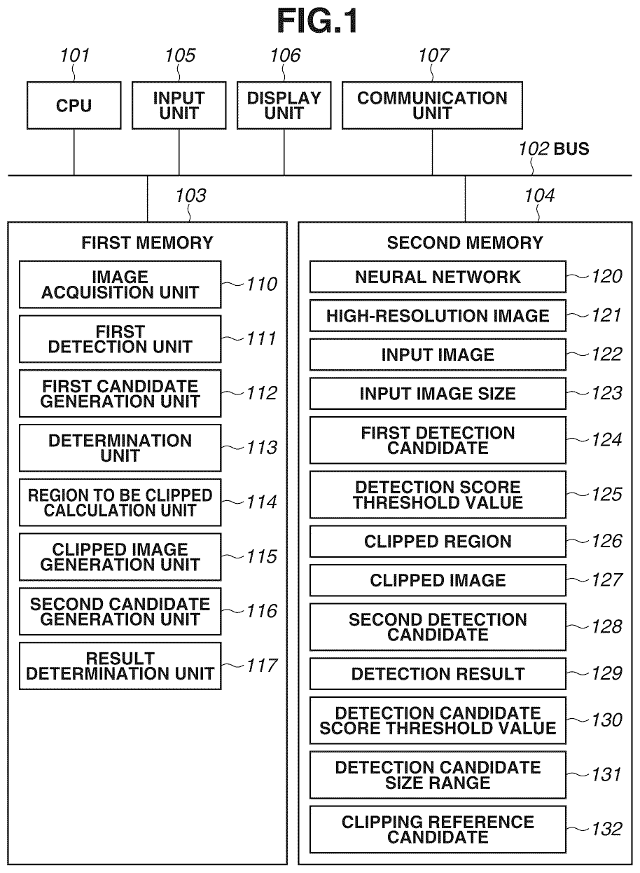

FIG. 1 illustrates an example of the configuration of an information processing apparatus according to one or more embodiments. The information processing apparatus according to the one or more embodiments includes a central processing unit (CPU) 101, a first memory 103, a second memory 104, an input unit 105, a display unit 106, and a communication unit 107. The CPU 101, the first memory 103, the second memory 104, the input unit 105, the display unit 106, and the communication unit 107 are communicably connected via a bus 102.

The CPU 101 controls the entire information processing apparatus in one or more embodiments. The first memory 103 and the second memory 104 store therein a control program and various kinds of data that allow the information processing apparatus according to one or more embodiments to perform various kinds of processing (e.g., by the CPU 101, by one or more units discussed herein, etc.). The first memory 103 and the second memory 104 are realized by, for example, a memory or an auxiliary storage device. The input unit 105 is realized by an input device such as a keyboard or a touch panel, and receives an input from a user. The display unit 106 is realized by a display device such as a liquid crystal display, and displays various kinds of information such as a processing result to present them to the user. The communication unit 107 transmits and receives data via communication with another apparatus.

In the example illustrated in FIG. 1, the first memory 103 mainly stores the control program therein, and the second memory 104 mainly stores the various kinds of data therein. The control program, the various kinds of data, and the like stored in the first memory 103 and the second memory 104 are not limited to the examples illustrated in FIG. 1.

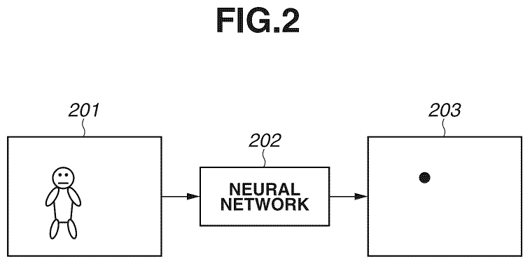

The second memory 104 stores therein a neural network 120, which is a model trained to detect the subject set as the detection target. The neural network 120 according to one or more embodiments is trained in such a manner that an input image 201 is received as an input and an inference map 203 is acquired when the input image 201 is input to a neural network 202 as illustrated in FIG. 2.

The neural network 120 is trained to output, for example, such a map that the value increases in a region where the subject set as the detection target is present and reduces in regions other than that in the image. The inference map 203 is illustrated as if it is a binary image with a high value in black and a low value in white for simplification of the illustration, but is inferred in such a manner that the map value increases as it is located closer to the center of the detection target and reduces as it is located farther away from the center of the detection target. The neural network 120 is generally configured in such a manner that the inference map 203 is output in a smaller size than the input image 201, but will be described as being configured in such a manner that the inference map 203 is output in the same size as the input image 201 for simplification of the description.

The control program stored in the first memory 103 includes at least a program for causing the execution of processing according to one or more embodiments that will be described below. By executing the control program, the CPU 101 functions as an image acquisition unit 110, a first detection unit 111, a first candidate generation unit 112, a determination unit 113, a region to be clipped calculation unit 114, a clipped image generation unit 115, a second candidate generation unit 116, and a result determination unit 117. Each of these units may be realized by software using the CPU 101 or may be partially realized by hardware such as an electronic circuit.

In one or more embodiments, the first detection unit 111 performs object detection processing for detecting a predetermined object (the subject set as the detection target) from an input image using the neural network 120 trained in advance. For example, the first detection unit 111 detects a region of a human face from the image using the neural network 120. The neural network 120 outputs the inference map 203 with respect to the input image 201 as illustrated in FIG. 2. A result of the detection by the first detection unit 111 is output as information indicating a detection region (a region where the subject set as the detection target is present) in the input image and a detection score. For example, for a region where the map value in the inference map 203 output from the neural network 120 is higher than a predetermined threshold value, the first detection unit 111 derives a bounding box drawn so as to encompass this region, and outputs it as the detection region. The bounding box may be expressed by a detection position and a detection size such as information indicating central coordinates, a width, and a height of a rectangular region. The information regarding the bounding box may be expressed using vertex coordinates of the rectangular region without being limited to the central coordinates of the rectangular region. The detection score can be acquired by, for example, using the highest map value in the bounding box region as the detection score. In this manner, the first detection unit 111 estimates and outputs the detection region and the detection score regarding the subject set as the detection target with respect to the input image 201. The first detection unit 111 outputs a detection result list with a pair of detection region and detection score listed as one detection result. Because some cases yield not a single detection result and other cases yield one or more detection results with respect to one input image, the first detection unit 111 outputs a list including zero or more detection results.

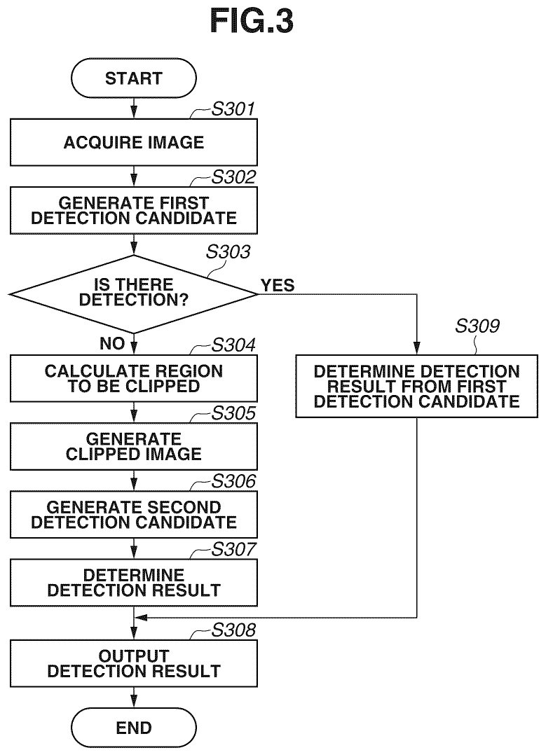

FIG. 3 is a flowchart illustrating an example of processing by the information processing apparatus according to one or more embodiments.

The object detection processing for detecting the subject set as the detection target from the input image will be described with reference to FIG. 3.

In step S301, the image acquisition unit 110 acquires a detection target image to be subjected to the object detection processing. The image acquisition unit 110 generates an input image in a predetermined size to be input to the neural network 120 based on the acquired detection target image, and stores it into the memory. The detection target image may be acquired by reading an image specified by the user via the input unit 105 or may be acquired by receiving an image from an external imaging apparatus via the communication unit 107. In one or more embodiments, the detection target image acquired by the image acquisition unit 110 is assumed to be an image at a higher resolution than an input image 122. The image acquisition unit 110 stores the acquired high-resolution detection target image into the second memory 104 as a high-resolution image 121. After that, the image acquisition unit 110 resizes the high-resolution image 121 into the image in the predetermined input image size (reduces the resolution), and stores it into the second memory 104 as the input image 122. The input image 122 is an example of a first image. The image size of the input image 122 is an image size acceptable as input to the neural network 120, and is assumed to be determined in advance when the neural network 120 is trained and stored in advance in the second memory 104 as an input image size 123.

The detection target image acquired by the image acquisition unit 110 has been described as an image at a higher resolution than the input image 122, but is not limited thereto. For example, the image acquisition unit 110 may be configured to acquire an image in a size equal to the input image size 123 as the detection target image. In this case, the above-described image resizing processing is unnecessary. Further, for example, the image acquisition unit 110 may function to acquire an image in a smaller size than the input image size 123 as the detection target image, and, in this case, may prepare the input image 122 by resizing the acquired image so as to enlarge the image size thereof and storing a resultant image as the input image 122.

In step S302, the first candidate generation unit 112 generates a first detection candidate by carrying out the object detection using the neural network 120 with respect to the input image 122, and stores it into the second memory 104 as a first detection candidate 124. The first candidate generation unit 112 inputs the input image 122 to the first detection unit 111 and stores the acquired detection result (the pair of detection region and detection score) into the second memory 104 as the first detection candidate 124. The second memory 104 stores therein the list including zero or more detection results as the first detection candidate 124 as described above.

In step S303, the determination unit 113 determines whether the first detection candidate 124 stored in step S302 includes a detection result (detection candidate) in which the detection score is equal to or higher than a predetermined detection score threshold value. The detection score threshold value is stored in advance in the second memory 104 as a detection score threshold value 125. The detection score threshold value 125 is a threshold value for determining how high detection score is to be included in the detection result to treat this result as the subject being detected, i.e., determine that the subject set as the detection target is detected, and may be adjusted according to the degree to which the user allows false detection and non-detection. The detection score threshold value 125 is an example of a first threshold value. A reduction in the value of the detection score threshold value 125 makes false detection more likely but makes non-detection less likely, and an increase in the value of the detection score threshold value 125 makes false detection less likely but makes non-detection more likely. If the determination unit 113 determines that the first detection candidate 124 includes no detection result (detection candidate) in which the detection score is equal to or higher than the detection score threshold value 125 (NO in step S303), the processing proceeds to step S304. On the other hand, if the determination unit 113 determines that the first detection candidate 124 includes a detection result (detection candidate) in which the detection score is equal to or higher than the detection score threshold value 125 (YES in step S303), the processing proceeds to step S309. In step S309, the result determination unit 117 stores the detection result (detection candidate) in which the detection score is equal to or higher than the detection score threshold value 125 in the first detection candidate 124 into the second memory 104 as a detection result 129. After that, the processing proceeds to step S308.

In step S304, the region to be clipped calculation unit 114 calculates a region to be clipped based on the first detection candidate 124 and stores it into the second memory 104 as a clipped region 126. The details of the processing for calculating the region to be clipped in this step S304 will be described below.

In step S305, the clipped image generation unit 115 generates a clipped image based on the clipped region 126 and stores it into the second memory 104 as a clipped image 127. The clipped image 127 is an example of a second image. The clipped image generation unit 115 is assumed to generate the clipped image 127 from the high-resolution image 121 based on the clipped region 126 in one or more embodiments, but is not limited thereto. For example, if the high-resolution image is not acquired as the detection target image as described in the description about the above-described image acquisition unit 110, the clipped image generation unit 115 may, for example, generate the clipped image 127 from the input image 122. If the clipped region 126 is empty when the processing in step S305 is started, the processing according to the present flowchart may directly proceed to step S308 and be ended with no detection result, although this is not illustrated in FIG. 3.

In the following description, the generation of the clipped image 127 by the clipped image generation unit 115 will be described.

The clipped image generation unit 115 first calculates a position corresponding to the central position of the clipped region 126 in the high-resolution image 121. This can be calculated by, for example, recording a resizing ratio (a reduction ratio) or the like used when the image size is resized by the image acquisition unit 110 into the second memory 104 or the like in advance and converting the central position of the clipped region 126 using this resizing ratio or the like. Next, the clipped image generation unit 115 calculates a rectangular region having a size equal to the input image size 123 with the center thereof placed at the central position of the clipped region 126 in the high-resolution image 121, and clips a partial region from the high-resolution image 121 according to the calculated rectangular region. Then, the clipped image generation unit 115 stores the partial image clipped from the high-resolution image 121 into the second memory 104 as the clipped image 127. If the rectangular region fails to be entirely contained in the high-resolution image 121 when the partial image is clipped from the high-resolution image 121, pixel values in the region extending beyond the high-resolution image 121 may be filled with zero. Alternatively, the rectangular region may be shifted so as to prevent the rectangular region from extending beyond the high-resolution image 121 within a range that allows the clipped region 126 to be kept within the rectangular region. The clipped image 127 generated by the clipped image generation unit 115 in this manner is formed into such an image that a portion corresponding to the clipped region 126 in the input image 122 is enlarged. The image of the clipped region 126 is acquired by clipping from the high-resolution image 121 instead of enlarging the image by complementing pixel values, and therefore can be acquired without impairing the image quality. However, in some cases, an image in the same size as the input image size 123 is acquired as the detection target image as described in the description about the image acquisition unit 110. In such a case, the image of the clipped region 126 may be acquired by enlarging the image by complementing pixel values.

In step S306, the second candidate generation unit 116 carries out the object detection using the neural network 120 with respect to the clipped image 127 to generate a second detection candidate, and stores it into the second memory 104 as a second detection candidate 128. The second candidate generation unit 116 inputs the clipped image 127 to the first detection unit 111 and stores the acquired detection result (the pair of detection region and detection score) into the second memory 104 as the second detection candidate 128. The second memory 104 stores therein a list including zero or more detection results as the second detection candidate 128 similarly to the processing in step S302. However, in this step S306, the information about the detection region included in the detection result is stored after being converted from image coordinates of the clipped image 127 into image coordinates in an image coordinate system of the input image 122 based on the information about the clipped region 126.

In step S307, the result determination unit 117 determines a final detection result based on the detection result regarding the subject set as the detection target acquired from the processing performed so far, and stores it into the second memory 104 as the detection result 129. The details of the processing for determining the detection result in this step S307 will be described below.

In step S308, the result determination unit 117 outputs the detection result based on the detection result 129. The result determination unit 117 can output the detection result by, for example, overlaying a rectangular frame or the like indicating the detection region acquired as the detection result on the input image 122 and displaying this image on the display unit 106. When not even a single detection result is stored in the detection result 129, the result determination unit 117 can output the detection result by, for example, presenting a display indicating that not even a single subject set as the detection target is detected on the display unit 106 or the like. The usage of the detection result is not limited to displaying the detection result. It is also possible that another processing is performed using the detection result. For example, the detection result may be used in the following manner. The information processing apparatus receives an image acquired by an image sensor in an external imaging apparatus via the communication unit 107 as the input image 122. Then, the information processing apparatus performs the object detection processing on the input image 122, and transmits the detection result 129 of the object detection to the external imaging apparatus via the communication unit 107. The external imaging apparatus performs automatic focus control so as to focus the imaging apparatus based on a face detection region indicated by the received detection result 129.

After the processing in step S308 is performed, the processing according to the present flowchart ends.

In the above description, the processing proceeds to step S304 only if the determination unit 113 determines that the first detection candidate 124 includes no detection result (detection candidate) in which the detection score is equal to or higher than the detection score threshold value 125 in step S303 (NO in step S303). However, the present processing is not limited thereto, and may be arranged so as to always proceed to step S304 regardless of whether the first detection candidate 124 includes a detection result (detection candidate) in which the detection score is equal to or higher than the detection score threshold value 125. In the case where the processing is arranged so as to always proceed to step S304, the result determination unit 117 can fulfill its function by determining the final detection result from both the first detection candidate 124 and the second detection candidate 128 in step S307. The processing arranged in this manner allows the second detection candidate 128 to be generated regardless of the result of the first detection candidate 124 and allows the final detection result to be determined by selecting a candidate assigned with a higher detection score and more likely to correctly detect the subject from both the detection candidates.

Next, the processing for calculating the region to be clipped in step S304 will be described. Several possible examples of the processing for calculating the region to be clipped will be described now. In any of the examples that will be described below, the region to be clipped calculation unit 114 may clear out the clipped region 126 and end the processing when not even a single detection result is included in the first detection candidate 124.

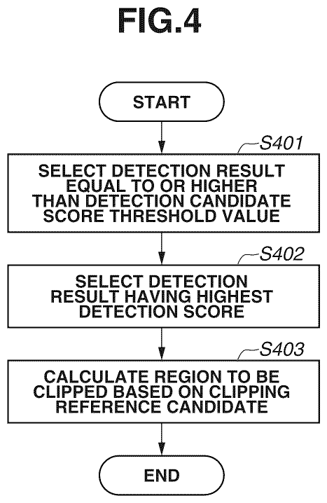

As one example, the region to be clipped calculation unit 114 calculates the clipped region 126 based on a detection result (detection candidate) in which the detection score included in the detection result is equal to or higher than a predetermined detection candidate score threshold value and the detection score is the highest in the first detection candidate 124. This example of the processing for calculating the region to be clipped will be described with reference to FIG. 4. The detection candidate score threshold value is set in advance in the second memory 104 as a detection candidate score threshold value 130. Since the processing for calculating the region to be clipped is performed when the first detection candidate 124 is determined to include no detection result (detection candidate) in which the detection score is equal to or higher than the detection score threshold value 125, the detection candidate score threshold value 130 is set to a value lower than the detection score threshold value 125. The detection candidate score threshold value 130 is an example of a second threshold value.

FIG. 4 is a flowchart illustrating the example of the processing for calculating the region to be clipped.

In step S401, the region to be clipped calculation unit 114 selects a detection result (detection candidate) in which the detection score is equal to or higher than the detection candidate score threshold value 130 from the first detection candidate 124. If the first detection candidate 124 includes no detection result (detection candidate) in which the detection score is equal to or higher than the detection candidate score threshold value 130, the processing according to the present flowchart may end.

In step S402, the region to be clipped calculation unit 114 selects one detection result (detection candidate) for which the detection score is the highest among the detection result(s) (detection candidate(s)) selected in step S401, and stores it into the second memory 104 as a clipping reference candidate (a detection candidate that serves as the basis for calculating the region to be clipped) 132.

In step S403, the region to be clipped calculation unit 114 calculates the region to be clipped based on the information regarding the detection region of the clipping reference candidate 132, and stores it into the second memory 104 as the clipped region 126. The region to be clipped calculation unit 114 may directly store the detection region of the clipping reference candidate 132 as the clipped region 126 or may store a region enlarged, reduced, or the like according to a separately defined rule as the clipped region 126.

Designing the processing for calculating the region to be clipped in this manner leads to canceling the subsequent processing by determining that no detection target is present in the input image 122 if the first detection candidate 124 includes no detection result (detection candidate) in which the detection score is equal to or higher than the detection candidate score threshold value 130. This can contribute to avoiding execution of excessive processing and further can reduce a possibility that false detection is yielded by clipping an image and attempting the detection again. The present processing may be arranged in such a manner that one detection result (detection candidate) having the highest detection score is necessarily selected from the first detection candidate 124 and stored as the clipping reference candidate 132 by setting the detection candidate score threshold value 130 to zero.

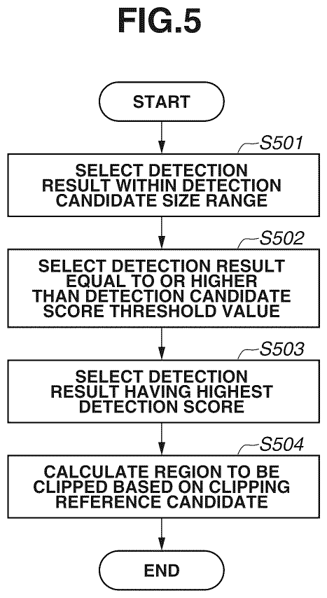

As another example, the region to be clipped calculation unit 114 selects a clipping reference candidate from the first detection candidate 124 under the condition that the detection size of the detection region falls within a predetermined detection candidate size range, and calculates the clipped region 126. This example of the processing for calculating the clipped region will be described with reference to FIG. 5. The detection candidate size range is set in advance in the second memory 104 as a detection candidate size range 131. The object detection processing may yield a low detection score due to a small image size of the subject and end up in non-detection, but a detection region large in size in the first detection candidate 124 cannot be considered to be assigned with a low detection score due to the image size of the subject. The detection region large in size but assigned with a low detection score is considered to be highly likely not to look like the detection target in terms of the picture in the image.

FIG. 5 is a flowchart illustrating the example of the processing for calculating the region to be clipped.

In step S501, the region to be clipped calculation unit 114 selects a detection result (detection candidate) in which the detection size of the detection region falls within the detection candidate size range 131 from the first detection candidate 124. If the first detection candidate 124 includes no detection result (detection candidate) in which the detection size of the detection region falls within the detection candidate size range 131, the processing according to the present flowchart may end.

In step S502, the region to be clipped calculation unit 114 selects a detection result (detection candidate) in which the detection score is equal to or higher than the detection candidate score threshold value 130 from the detection result(s) (detection candidate(s)) selected in step S501. If no detection result (detection candidate) in which the detection score is equal to or higher than the detection candidate score threshold value 130 is included in the detection result(s) (detection candidate(s)) selected in step S501, the processing according to the present flowchart may end.

In step S503, the region to be clipped calculation unit 114 selects one detection result (detection candidate) in which the detection score is the highest among the detection result(s) (detection candidate(s)) selected in step S502, and stores it into the second memory 104 as the clipping reference candidate 132.

In step S504, the region to be clipped calculation unit 114 calculates the region to be clipped based on the information regarding the detection region of the clipping reference candidate 132, and stores it into the second memory 104 as the clipped region 126. The region to be clipped calculation unit 114 may directly store the detection region of the clipping reference candidate 132 as the clipped region 126 or may store a region enlarged, reduced, positionally displaced, or the like according to a separately defined rule based on the information regarding the detection region as the clipped region 126. Examples thereof include that, if the detection target is a human eye, the rule is defined to allow the whole human face to be contained in the region based on the detection position and the size of the eye. Alternatively, the clipped region may be calculated according to such a rule that the ratio of the size of the detection region to the size after the clipping matches a predetermined value. In a case where the accuracy of the detection processing is affected by the ratio between the size of the input image and the size of the detection target, the improvement of the detection accuracy can be expected by calculating the region to be clipped so as to achieve an appropriate size ratio.

Calculating the region to be clipped in this manner allows priority to be given to detection of a candidate whose detection score does not increase sufficiently due to a small image size of the subject, and allows the clipped region to be calculated based thereon. Further, this processing can avoid execution of unnecessary processing on a candidate whose detection score reduces simply because the picture of the image does not look like the detection target. The present processing may be arranged in such a manner that one detection result (detection candidate) having the highest detection score is necessarily selected among the detection result(s) (detection candidate(s)) selected in step S501 and is stored as the clipping reference candidate 132 by setting the detection candidate score threshold value 130 to zero.

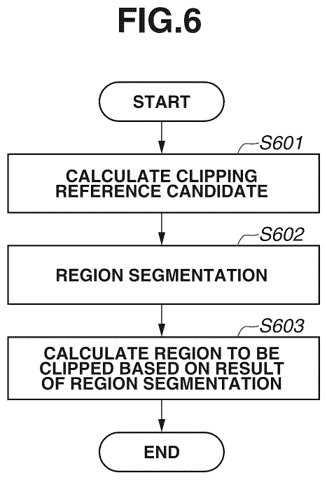

Further, as another example, the region to be clipped calculation unit 114 carries out region segmentation based on the detection region of the clipping reference candidate 132 in the above-described examples illustrated in FIGS. 4 and 5, and calculates the clipped region 126 based on a result of the region segmentation. This example of the processing for calculating the region to be clipped will be described with reference to FIG. 6. The region segmentation in this case is a method for segmenting an image into a foreground and a background, and may also be called as blob detection. For example, a method using graph cut is known. The graph cut is one of methods for segmenting an image into a foreground including a region provided as a seed region in the image and a background other than that.

FIG. 6 is a flowchart illustrating the example of the processing for calculating the region to be clipped.

In step S601, the region to be clipped calculation unit 114 calculates the detection region of the clipping reference candidate 132 using the method of the above-described example illustrated in FIG. 4 or 5.

In step S602, the region to be clipped calculation unit 114 carries out the region segmentation based on the detection region of the clipping reference candidate 132 calculated in step S601. For example, the region to be clipped calculation unit 114 applies the graph cut while setting the detection region of the clipping reference candidate 132 as the seed region of the graph cut, thereby segmenting the image into the foreground and the background other than that.

In step S603, the region to be clipped calculation unit 114 calculates a rectangular region encompassing a region determined to be the foreground by the region segmentation carried out in step S602, calculates the region to be clipped based thereon, and stores it into the second memory 104 as the clipped region 126.

Calculating the region to be clipped in this manner allows the clipped region to be clipped as a wider region including the region defined as the detection target as a part thereof. For example, if a central portion of a human face is learned to be the subject set as the detection target, this causes the detection region of the detection result to include only a central portion of a face, but the region segmentation based on the detection region allows the image to be clipped so as to contain a whole head portion or a whole human body. As a result, the accuracy of the detection processing can be improved when the second detection candidate is generated in the processing supposed to be performed after that. This is because the neural network 120 trained to detect the subject set as the detection target learns not only a partial region including the detection target but also a picture indicating the vicinity of it, and therefore may be able to more accurately detect an image including the vicinity of the detection target than an image including only the detection target. For example, the detection accuracy may be higher when the object detection is applied to an image displaying a whole head portion and the vicinity thereof or a whole human body than when the object detection is applied to an image in which only a central portion of a face is clipped. Further, the present processing allows the image to be clipped while the region of the object including the detection region of the clipping reference candidate 132 is set in a well-balanced manner compared with the image being clipped with the detection region of the clipping reference candidate 132 centered therein. For example, the present processing allows the image to be clipped in which the whole human body is clipped with the center of the human body centered therein instead of the image being clipped with the face centered therein, thereby achieving more accurate detection. This advantageous effect can be further effectively acquired when, for example, the detection target is learned to be only a small part of an object. This example has been described citing the graph cut as an example of the region segmentation, but the method for the region segmentation is not limited thereto.

Next, the processing for determining the detection result in step S307 will be described. Several possible examples of the processing for determining the detection result will be described now. The processing for determining the detection result that will be described now is merely examples, and the method for determining the final detection result shall not be limited thereto.

As one example, the result determination unit 117 selects a detection result (detection candidate) in which the detection score included in the detection result is the highest from the second detection candidate 128 to determine it as the final detection result, and stores it as the detection result 129. In this example, the result determination unit 117 determines the detection result 129 only based on the detection score included in the detection result.

As another example, the result determination unit 117 selects a detection result (detection candidate) in which the detection size of the detection region included in the detection result falls within a predetermined range from the second detection candidate 128. Subsequently, the result determination unit 117 determines a detection result (detection candidate) in which the detection score is the highest among the selected detection result(s) (detection candidate(s)) as the final detection result, and stores it as the detection result 129. The object detection processing may yield a low detection score due to a small image size of the subject, ending up in non-detection. However, a detection region large in detection size in the second detection candidate 128 cannot be considered to be assigned with a low detection score due to the image size of the subject in the first detection candidate 124. Selecting a detection result (detection candidate) in which the detection size of the detection region falls within the predetermined range from the second detection candidate 128 can prevent a candidate not considered to be assigned with a low detection score due to the image size of the subject from being accidentally set as the final detection result. This predetermined range regarding the detection size may be the same as the detection candidate size range 131 in the second memory 104 or may be set to another range value for the present processing.

Further, as another example, the result determination unit 117 compares the detection region of the clipping reference candidate 132 selected from the first detection candidate 124 by the region to be clipped calculation unit 114 and the detection region of the second detection candidate 128 to determine the final detection result, and stores it as the detection result 129. In one or more embodiments, the clipping reference candidate 132 is determined based on a detection candidate assigned with a detection score that does not satisfy the detection score threshold value 125 in the first detection candidate 124, and the second detection candidate 128 is generated from the clipped image 127 determined based on the clipping reference candidate 132. This means that a detection result corresponding to the detection region of the clipping reference candidate 132 is included in the second detection candidate 128, provided that the detection has been appropriate. Detection results (detection candidates) other than that in the second detection candidate 128 are results newly detected by performing the object detection processing on the clipped image 127 again, and false detection may newly occur therein. This example is intended to avoid such false detection. The result determination unit 117 determines as the final detection result a detection result (detection candidate) in which the detection score is the highest among the detection result(s) (detection candidate(s)) having the same position and size of the detection region as the clipping reference candidate 132 in the second detection candidate 128, and stores it as the detection result 129. Whether the position and the size of the detection region are the same as those of the clipping reference candidate 132 can be determined based on, for example, how much the detection regions of them overlap each other. If no overlap exists therebetween, this determination may be made by, for example, selecting a detection result having a position and size of the detection region close to those of the clipping reference candidate 132.

The above-described examples have been described assuming that one clipping reference candidate 132 is selected by way of example, but may be arranged so as to select a plurality of clipping reference candidates. For example, a plurality of detection results (detection candidates) in which the detection score is equal to or higher than the detection candidate score threshold value 130 and the detection score is high in the first detection candidate 124 may be prioritized to be selected as clipping reference candidates. Alternatively, for example, a plurality of detection results (detection candidates) in which the size of the detection region falls within the detection candidate size range 131, the detection score is equal to or higher than the detection candidate score threshold value 130, and the detection score is high in the first detection candidate 124 may be prioritized to be selected as clipping reference candidates. Then, the processing for generating the clipped image and the processing for generating the second detection candidate, which are supposed to be performed after that, may be performed on each of the plurality of clipping reference candidates as necessary.

In one or more embodiments, when the object detection with respect to the input image 122 results in non-detection, the clipped image 127 is generated by clipping based on the detection result of the object detection with respect to the input image 122, and the object detection is carried out with respect to the clipped image 127. Such object detection allows the information processing apparatus to detect the subject that is assigned with a detection score not increasing due to a small image size of the subject and would conventionally have been determined to be non-detection. Further, clipping the image based on the detection result indicating non-detection allows the information processing apparatus to carry out the object detection by efficiently identifying a position in the image where the subject set as the detection target is likely to be present, thereby improving the detection performance. In this manner, according to one or more embodiments, the detection accuracy can be improved in the object detection from an image.

Further, in the case where the information processing apparatus is configured to determine the final detection result based on both the first detection candidate determined to be non-detection due to a low detection score and the second detection candidate, one or more embodiments may make it less likely to yield false detection due to clipping the image and performing the detection processing again.

### Configuration(s) for One or More Additional Embodiments

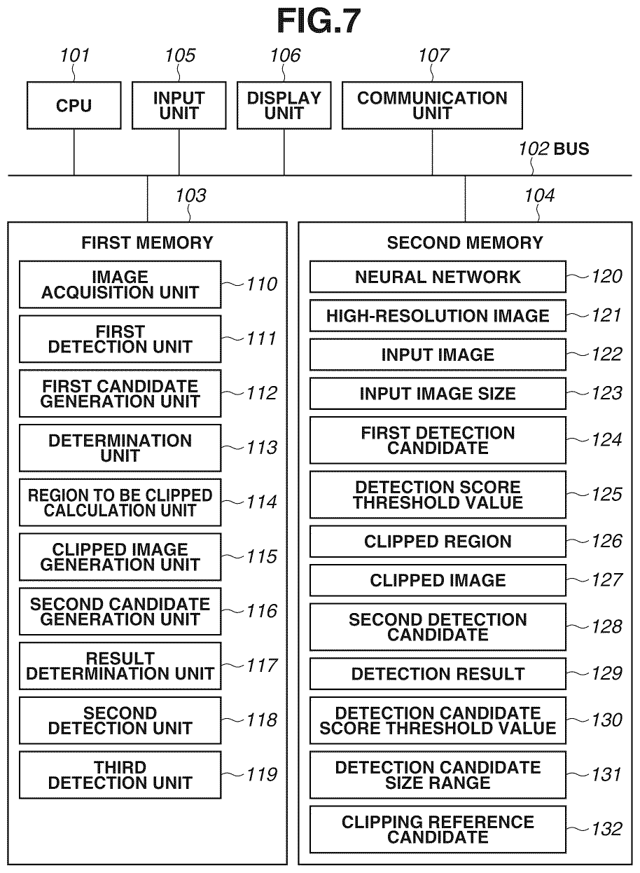

FIG. 7 illustrates an example of the configuration of an information processing apparatus according to one or more additional embodiments. The information processing apparatus according to one or more embodiments is configured generally similarly to one or more of the above-described embodiments, but additionally includes a second detection unit 118 and a third detection unit 119 in the first memory 103. Further, one or more additional embodiments may be different from one or more of the above-described embodiments in terms of the configuration of the neural network 120 and the processing for calculating the region to be clipped. In the following description, one or more embodiments will be described focusing on them.

The configuration of the neural network 120 according to one or more additional embodiments, and the second detection unit 118 and the third detection unit 119 illustrated in FIG. 7 will be described.

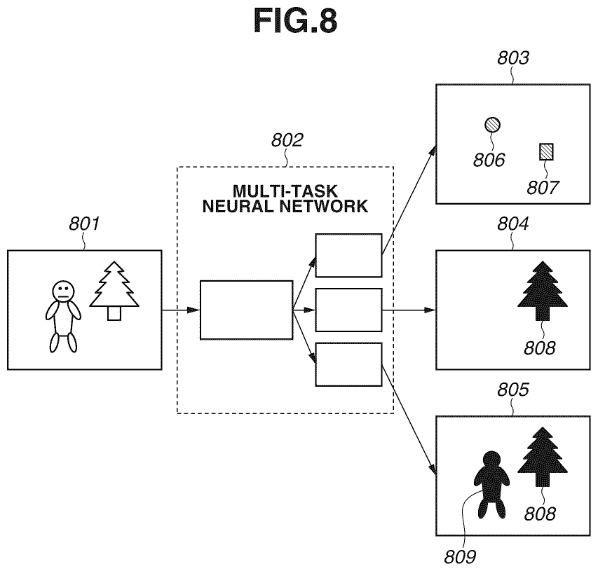

FIG. 8 illustrates the configuration of the neural network 120 according to one or more additional embodiments. The neural network 120 according to one or more additional embodiments is configured to output a plurality of inference maps with respect to one input image, and is trained to output respective inference maps defined for different detection targets. The neural network 120 is partially shared and is configured to branch in the middle thereof. Such a neural network is called a multi-task neural network.

In FIG. 8, an input image 801 is an example of the input image. In this example, the input image 801 is an image in which a human figure and a tree are imaged. A multi-task neural network 802 outputs inference maps 803 to 805, which are examples of the inference maps.

The multi-task neural network 802 is trained to output the first inference map 803 defined in such a manner that the map value increases in a human face region. The first inference map 803 illustrates an example that reacts to a human face region 806 and a tree bark region 807, which is not a human face. Hatching in the region 806 and the region 807 indicates that the map values of these regions are lower than a map value of a region 808 in the second inference map 804, which will be described below. In one or more additional embodiments, assume that the first detection unit 111 detects a human face based on this first inference map 803. The content of the processing by the first detection unit 111 according to one or more additional embodiments is similar to the first detection unit 111 according to one or more of the above-described embodiments.

Further, the multi-task neural network 802 is trained to output the second inference map 804 defined in such a manner that the map value increases in a tree region. In this example of the second inference map 804, a high map value is output in the tree region 808. The second detection unit 118 performs processing similar to the processing in which the first detection unit 111 detects a human face, and detects a tree based on this second inference map 804. One or more embodiments will be described assuming that the second detection unit 118 detects a tree, but the second detection unit 118 is not limited thereto and may be configured to detect another subject set as the detection target. For example, the second detection unit 118 may detect an animal such as a dog or a cat, or a vehicle.

Further, the multi-task neural network 802 is trained to output the third inference map 805 defined in such a manner that the map value increases in a region that looks like some object without specifying the category of the subject set as the detection target. In this example of the third inference map 805, a high map value is output in the tree region 808 and a region 809 of a whole human body. The third detection unit 119 performs processing similar to the processing in which the first detection unit 111 detects a human face, and detects any object based on this third inference map 805.

In this manner, the second detection unit 118 and the third detection unit 119 carry out the object detection based on the inference maps output from the neural network 120. The contents of the processing procedures performed by the second detection unit 118 and the third detection unit 119 are similar to those of the processing performed by the first detection unit 111, and therefore the details thereof will not be described here. The inference maps output from the multi-task neural network 802 learn different respective intended purposes, and the respective intended purposes will be referred to as tasks. In this example, their intended purposes will be referred to as a human face detection task, a tree detection task, and an any-object detection task.

Next, the processing for calculating the region to be clipped according to one or more additional embodiments will be described. This processing will be described citing an example that attempts to detect a human face as the detection target similarly to one or more of the above-discussed embodiments, and assuming that the detection score does not increase because the subject image size of the human face is small, and the clipped image is generated and the object detection processing is performed again.

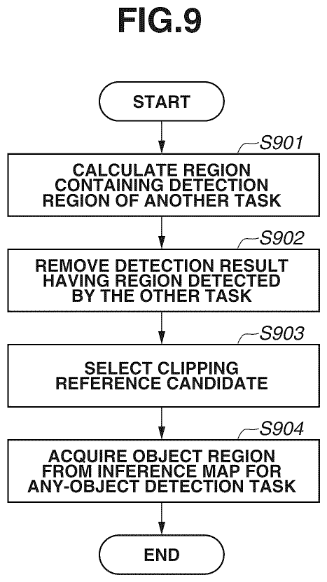

FIG. 9 is a flowchart illustrating the example of the processing for calculating the region to be clipped according to one or more additional embodiments.

In step S901, the region to be clipped calculation unit 114 compares the first inference map 803 for the human face detection task, and the second inference map 804 for another task, which learns detection of a specific object other than the any-object detection task. The region to be clipped calculation unit 114 calculates a region in the input image 122 highly likely to contain the subject set as the detection target that the other task attempts to detect by comparing the first inference map 803 for the human face detection task and the second inference map 804 for the other task. This can be achieved by calculating a region in which the value of the second inference map 804 is higher than the value of the first inference map 803. In the example illustrated in FIG. 8, the region to be clipped calculation unit 114 calculates a region in which the value of the second inference map 804 for the tree detection task is higher than the value of the first inference map 803 for the human face detection task. Therefore, the tree region 808 is supposed to be calculated in this example.

In step S902, the region to be clipped calculation unit 114 removes a detection result (detection candidate) corresponding to the region calculated in step S901 from the first detection candidate 124 for the human face detection task. In the example illustrated in FIG. 8, a detection result (detection candidate) corresponding to the region 807 present in the first inference map 803 for the human face detection task is removed.

In step S903, the region to be clipped calculation unit 114 selects a detection result (detection candidate) in which the detection score is the highest among the detection result(s) (detection candidate(s)) not removed in step S902, and stores this detection result into the second memory 104 as the clipping reference candidate 132.

In the example illustrated in FIG. 8, for example, the detection result (detection candidate) corresponding to the region 806 is selected and stored as the clipping reference candidate 132.

In step S904, the region to be clipped calculation unit 114 acquires the object region from the third reference map 805 for the any-object detection task based on the detection position of the clipping reference candidate 132. This can be achieved by, for example, calculating a bounding box encompassing a region in which the detection position of the clipping reference candidate 132 is located and the map value of the third inference map 805 for the any-object detection task is a predetermined value or higher. At this time, the bounding box may be calculated in consideration of the detection size of the clipping reference candidate 132. In the example illustrated in FIG. 8, a bounding box drawn so as to encompass the region 809 is acquired as the object region. Then, the region to be clipped calculation unit 114 calculates the region to be clipped based on the acquired object region and stores it into the second memory 104 as the clipped region 126.

One or more embodiments have been described citing the example in which the detection score reduces due to the small image size of the subject and the human face is determined to be non-detection for the human face detection. However, with the tree detection in focus, the detection score of the tree detection may reduce and the tree may be determined to be non-detection. In this case, a similar effect can be achieved by interchanging the face detection task cited as an example of the task of interest and the tree detection task cited as an example of the other task in the above description, and then performing similar processing.

Such object detection can allow the clipped region to be calculated based on results of the plurality of detection tasks, thereby preventing a clipped region inappropriate for the task of interest from being accidentally calculated. Further, compared with the processing for calculating the region to be clipped using the region segmentation described in one or more of the above-described embodiments, a region looking like any object can be acquired from one neural network according to one or more additional embodiments, which eliminates the necessity of the region segmentation and makes the processing less cumbersome.

According to the present disclosure, the detection accuracy may be improved in the object detection that detects the subject set as the detection target from the image.

### Other Embodiments

Embodiment(s) of the present disclosure may also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU), etc.) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims priority to and the benefit of Japanese Patent Application No. 2024-160703, filed Sep. 18, 2024, which is hereby incorporated by reference herein in its entirety.

What is claimed is:

1. An information processing apparatus comprising:
a first detection unit that operates to estimate a detection region and a detection score regarding a subject set as a detection target with respect to an input image;
a first candidate generation unit that operates to generate a first detection candidate regarding detection of the subject set as the detection target using the first detection unit with respect to a first image;
a region calculation unit that operates to calculate a region to be clipped based on the first detection candidate in a case where the first detection candidate does not include a detection candidate for which the detection score is equal to or higher than a first threshold value;
an image generation unit that operates to generate a second image by clipping from the first image based on the region to be clipped; and
a second candidate generation unit that operates to generate a second detection candidate regarding the detection of the subject set as the detection target using the first detection unit with respect to the second image.

2. The information processing apparatus according to claim 1, further comprising a determination unit that operates to determine whether the first detection candidate includes the detection candidate for which the detection score is equal to or higher than the first threshold value.

3. The information processing apparatus according to claim 1, wherein the image generation unit generates the second image in a same size as the first image based on an image clipped from the first image.

4. The information processing apparatus according to claim 1, wherein the first detection candidate includes a plurality of detection candidates, and the region calculation unit further operates to prioritize a detection candidate for which the detection score is equal to or higher than a second threshold value and the detection score is a highest detection score or is higher than a detection score for another detection candidate in the first detection candidate to select the detection candidate as a clipping reference candidate, and calculate the region to be clipped based on a detection region of the clipping reference candidate.

5. The information processing apparatus according to claim 1, wherein the first detection candidate includes a plurality of detection candidates, and the region calculation unit further operates to prioritize a detection candidate for which a size of the detection region falls within a predetermined range, the detection score is equal to or higher than a second threshold value, and the detection score is a highest detection score or is higher than a detection score for another detection candidate in the first detection candidate to select the detection candidate as a clipping reference candidate, and calculate the region to be clipped based on a detection region of the clipping reference candidate.

6. The information processing apparatus according to claim 1, wherein the region calculation unit calculates the region to be clipped based on a detection region of a detection candidate for which the detection score is the highest in the first detection candidate.

7. The information processing apparatus according to claim 1, wherein the region calculation unit calculates the region to be clipped based on a detection region of a detection candidate for which a size of the detection region falls within a predetermined range and the detection score is the highest in the first detection candidate.

8. The information processing apparatus according to claim 1, further comprising a result determination unit that operates to determine a detection result regarding the detection of the subject set as the detection target based on the first detection candidate and the second detection candidate.

9. The information processing apparatus according to claim 8, wherein the result determination unit further operates to determine a detection candidate corresponding to the first detection candidate in the second detection candidate as the detection result.

10. The information processing apparatus according to claim 8, wherein the result determination unit determines the second detection candidate as the detection result.

11. The information processing apparatus according to claim 8, wherein the result determination unit determines as the detection result a detection candidate in which a size of the detection region falls within a predetermined range for the second detection candidate.

12. The information processing apparatus according to claim 1, further comprising an image acquisition unit that operates to acquire an image at a higher resolution than the first image and reduce the resolution of the acquired high-resolution image to generate the first image.

13. The information processing apparatus according to claim 12, wherein the image generation unit generates the second image by clipping from the high-resolution image acquired by the image acquisition unit based on the region to be clipped.

14. The information processing apparatus according to claim 1, further comprising:
a second detection unit trained to detect a subject different from the subject set as the detection target from the input image; and
a third detection unit trained to detect any subject from the input image,
wherein the region calculation unit calculates the region to be clipped based on detection results output from the first detection unit, the second detection unit, and the third detection unit, respectively, with respect to the first image.

15. The information processing apparatus according to claim 14, wherein the region calculation unit does not select a detection region detected by the second detection unit as the region to be clipped.

16. An information processing method performed by an information processing apparatus, the information processing method comprising:
performing a first detection of estimating a detection region and a detection score regarding a subject set as a detection target with respect to an input image;
generating a first detection candidate regarding detection of the subject set as the detection target by performing the first detection with respect to a first image;
calculating a region to be clipped based on the first detection candidate in a case where the first detection candidate does not include a detection candidate for which the detection score is equal to or higher than a first threshold value;
generating a second image by clipping from the first image based on the region to be clipped; and
generating a second detection candidate regarding the detection of the subject set as the detection target by performing the first detection with respect to the second image.

17. A non-transitory computer-readable storage medium storing a computer program that, when read and executed by a computer, causes the computer to perform an information processing method, the information processing method comprising:
performing a first detection of estimating a detection region and a detection score regarding a subject set as a detection target with respect to an input image;
generating a first detection candidate regarding detection of the subject set as the detection target by performing the first detection with respect to a first image;
calculating a region to be clipped based on the first detection candidate in a case where the first detection candidate does not include a detection candidate for which the detection score is equal to or higher than a first threshold value;
generating a second image by clipping from the first image based on the region to be clipped; and
generating a second detection candidate regarding the detection of the subject set as the detection target by performing the first detection with respect to the second image.
